(19) United States
(12) Patent Application Publication
(10) Pub. No.: US 2006/0002682 A1
(43) Pub. Date: Jan. 5, 2006

(54) Recording apparatus and recording control method

(75) Inventor: Keiji Kanamori, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/170,436

(22) Filed: Jun. 30, 2005

(30) Foreign Application Priority Data
Jun. 30, 2004 (JP) 2004-193766

(51) Int. Cl. H04N 5/76; H04N 5/91

(52) U.S. Cl. 386/46; 386/83

(57) ABSTRACT

In a recording apparatus, when a time interval between a time to terminate recording of broadcast program data on channel A and a time to start recording of broadcast program data on channel B is shorter than a predetermined value, a system control section executes recording control processing to process the broadcast program data on channel A and the broadcast program data on channel B as one stream. Accordingly, the broadcast program data on channel A and the broadcast program data on channel B are stored in a file in storage as one consecutive broadcast program data piece. After this, the system control section divides the file containing the broadcast program data on channel A and the broadcast program data on channel B into a file containing the broadcast program data on channel A and a file containing the broadcast program data on channel B.

### CROSS-REFERENCE TO RELATED APPLICATIONS

This application is based upon and claims the benefit of priority from the prior Japanese Patent Application No. 2004-193766, filed on Jun. 30, 2004; the entire contents of which are incorporated herein by reference.

### BACKGROUND OF THE INVENTION

1. Field of the Invention

This invention relates to a recording apparatus capable of recording broadcast program data in storage as a file and a recording control method used with the apparatus.

2. Description of the Related Art

In recent years, a recording and reproducing apparatus for recording and reproducing broadcast program data of a TV broadcast program, etc., has been developed.

For example, JP-A-2003-101923 discloses a recording and reproducing apparatus for recording a received TV broadcast program in storage such as a hard disk drive. In the recording and reproducing apparatus, the TV broadcast program received by a TV tuner is compressed and coded and then is stored in a hard disk drive.

### BRIEF SUMMARY OF THE INVENTION

By the way, to store broadcast program data in storage such as a hard disk drive, it becomes necessary to perform processing to store the broadcast program data as a file. For example, before reception of broadcast program data is started, it becomes necessary to perform initialization processing containing processing of file creation and opening. After the termination of the reception of broadcast program data is started, it becomes necessary to perform termination processing containing processing of storing the data left in a data buffer in a file in the storage, processing of closing the file, etc.

Usually, two pieces of broadcast program data on different channels are stored as two different files. Thus, for example, if recording of broadcast program data (A) on one channel and recording of broadcast program data (B) on another channel broadcast consecutively are programmed, the broadcast program data (B) cannot be recorded during a predetermined time since the reception termination time of the broadcast program data (A). The reason is that it becomes necessary to perform termination processing corresponding to the broadcast program data (A) and initialization processing corresponding to the broadcast program data (B) after the reception termination of the broadcast program data (A).

It is therefore an object of the invention to provide a recording apparatus and a recording control method for making it possible to properly record a plurality of pieces of broadcast program data on different channels broadcast consecutively.

According to an aspect of the invention, there is provided a recording apparatus capable of recording in storage broadcast program data on a first channel and broadcast program data on a second channel specified with recording program information, the recording apparatus including: a determining unit configured to determine whether or not a time interval between a time to terminate recording of the broadcast program data on the first channel and a time to start recording of the broadcast program data on the second channel is shorter than a predetermined value; and a recording control unit configured to execute recording processing of recording the broadcast program data on the first channel and the broadcast program data on the second channel as consecutive broadcast program data when the time interval is shorter than the predetermined value.

This makes it possible to properly record a plurality of pieces of broadcast program data on different channels broadcast consecutively.

### BRIEF DESCRIPTION OF THE DRAWINGS

FIG. 1 is a drawing to show the configuration of a home network system using a recording apparatus according to one embodiment of the invention;

FIG. 2 is a block diagram to show the recording apparatus in FIG. 1;

FIG. 3 is a drawing to show an example of recording program information used with the recording apparatus in FIG. 1;

FIG. 4 is a drawing to describe a processing sequence required for storing broadcast program data specified with the recording program information in FIG. 3 in HDD;

FIG. 5 is a drawing to describe recording processing of storing broadcast program data on channel A and that on channel B as two different files;

FIG. 6 is a drawing to describe recording processing of storing broadcast program data on channel A and that on channel B as one file;

FIG. 7 is a drawing to show a format example of a file containing the broadcast program data on channel A and that on channel B; and

FIG. 8 is a flowchart to show a procedure of recording control processing executed by the recording apparatus in FIG. 1.

### DETAILED DESCRIPTION OF THE INVENTION

Referring now to the accompanying drawings, there is shown a preferred embodiment of the invention.

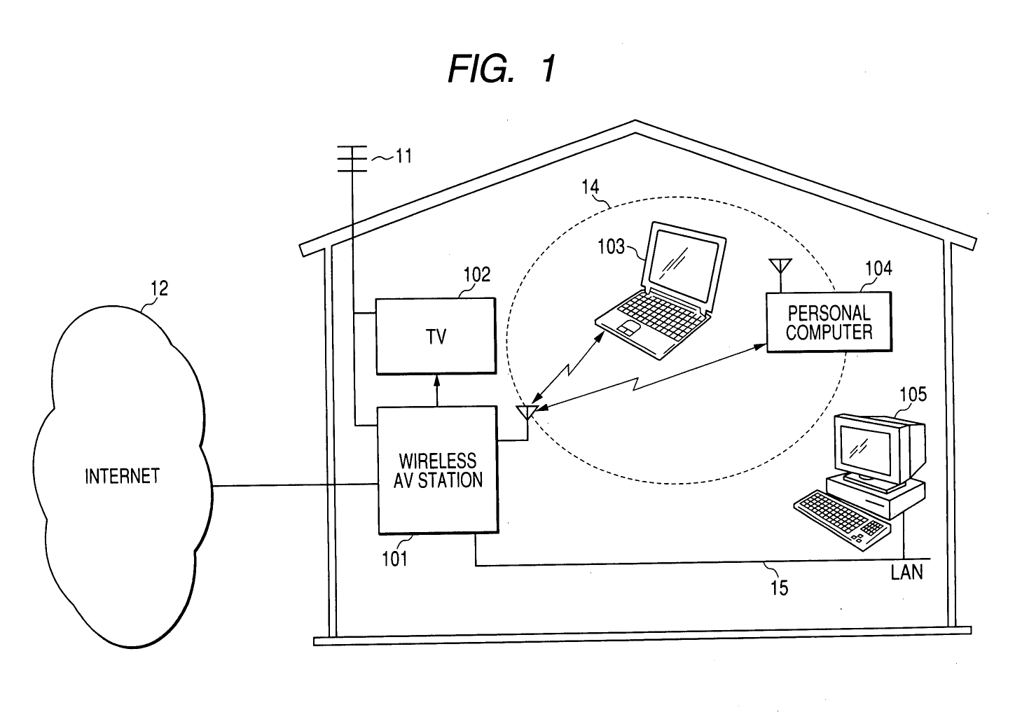

FIG. 1 shows the configuration of a home network system using a recording apparatus according to one embodiment of the invention. This home network system is made up of a wireless AV (audio video) station 101, a TV receiver 102, notebook personal computers 103 and 104, a desktop personal computer 105, etc.

The wireless AV station 101 is a recording and reproducing apparatus including a home server function. The wireless AV station 101 provides service of recording and reproducing broadcast program data (or simply, broadcast data) of a TV program, etc., and further service relating to browsing the Internet, etc., for the information processing terminals such as the personal computers 103 to 105 through a home wireless or wire local network.

The wireless AV station 101 is connected to an external global network (external network) such as the Internet 12 through a communication line, such as ISDN (Integrated Services Digital Network), ADSL (Asymmetrical Digital Subscriber Line), or CATV (Cable TV). Further, the wireless AV station 101 is connected to the information processing terminals in the house through the home wireless or wire network.

The personal computers 103 to 105 are terminals functioning as clients of the wireless AV station 101. The notebook personal computers 103 and 104 are provided each with a wireless communication device for enabling the notebook personal computers 103 and 104 to be connected to the wireless AV station 101 through a wireless communication network (wireless LAN) 14. The desktop personal computer 105 is connected to the wireless AV station 101 through a wire communication network (wire LAN) 15.

The wireless AV station 101 connects the personal computers 103 to 105 to the Internet 12 and transfers data between a Web site on the Internet and each of the personal computers 103 to 105.

An antenna cable connected to a TV broadcast reception antenna 11 installed outdoors is drawn into the house. The TV receiver 102 and the wireless AV station 101 are connected to the antenna cable. Broadcast program data transmitted from a broadcast station not only can be received and reproduced in the TV receiver 102, but also can be received in the wireless AV station 101. The wireless AV station 101 transmits received broadcast program data to the personal computers 103 to 105 through the home wireless or wire local network. The wireless AV station 101 contains a hard disk drive (HDD) as a large-capacity storage device for recording broadcast program data. The wireless AV station 101 can record broadcast program data specified according to recording program information set with each of the personal computers 103 to 105 in the hard disk drive as a file.

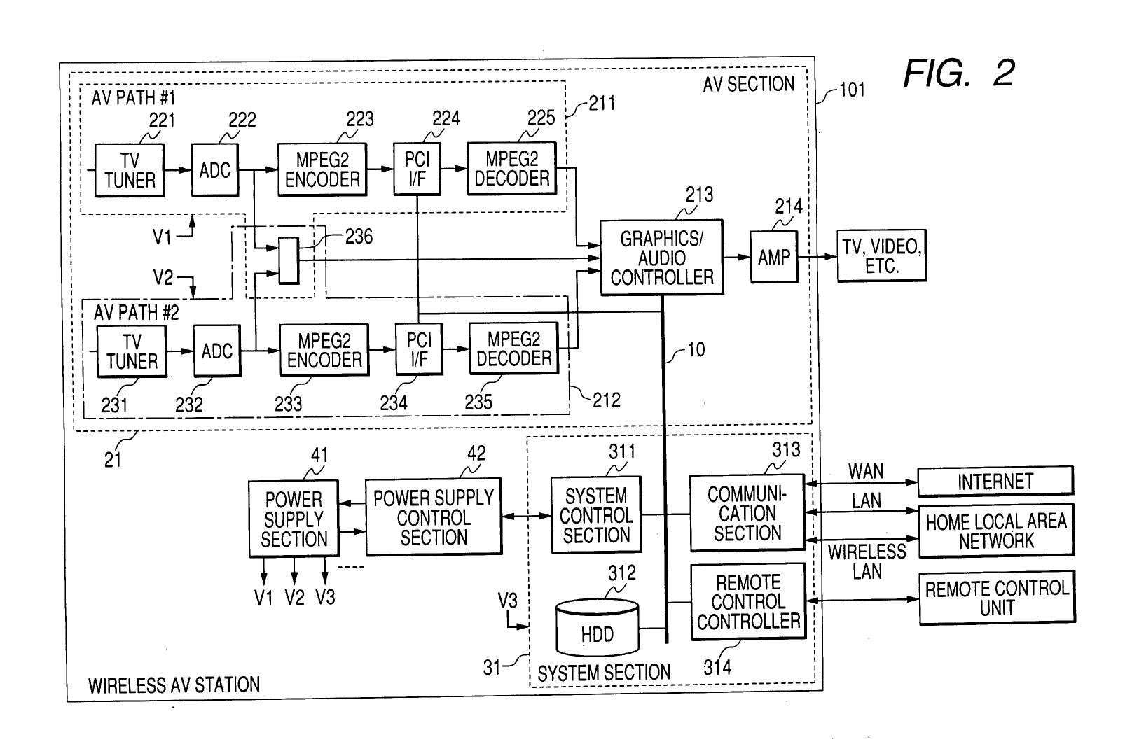

Next, the system configuration of the wireless AV station 101 will be discussed with reference to FIG. 2.

The wireless AV station 101 includes an audio video (AV) section 21, a system section 31, a power supply section 41, and a power supply control section 42, as shown in FIG. 2. The AV section 21 is a module for recording and reproducing broadcast program data. The AV section 21 includes a first AV path 211, a second AV path 212, a graphics/audio controller 213, and an amplifier (AMP) 214, and is connected to the system section 31 by a bus 10 such as a PCI bus. The first and second AV paths 211 and 212 are receivers for receiving broadcast program data, and are operated by independent power supplies V1 and V2 respectively. The power supplies V1 and V2 are provided by the power supply section 41.

The graphics/audio controller 213 is an output unit for outputting broadcast program data, etc., to the outside TV receiver 102 or an outside AV machine, and outputs the broadcast program data received by the AV path 211 or 212 or the broadcast program data recorded in an HDD 312 of the system section 31 to the outside TV receiver 102 or an outside AV machine.

The first AV path 211 includes a TV tuner 221, an analog-digital converter (ADC) 222, an MPEG2 encoder 223, a PCI bus interface (PCI I/F) 224, and an MPEG2 decoder 225. The TV tuner 221 is connected to the TV antenna 11. The TV tuner 221 is a device for receiving TV broadcast program data and receives the TV broadcast program data of the channel specified with a reception request from the system section 31. The system section 31 controls the TV tuner 221 through the PCI bus interface (PCI I/F) 224. The analog-digital converter (ADC) 222, the MPEG2 encoder 223, the PCI bus interface (PCI I/F) 224, and the MPEG2 decoder 225 make up a broadcast data processing section for processing the broadcast program data received by the TV tuner 221. The TV broadcast program data of one channel received by the TV tuner 221 is sent to the analog-digital converter (ADC) 222, which then converts the analog data into a digital signal.

To output the broadcast program data received by the TV tuner 221 to the TV receiver 102, the broadcast program data converted into the digital signal is sent to the graphics/audio controller 213 through a selector 236. On the other hand, to transmit the broadcast program data received by the TV tuner 221 to the requesting information processing terminal or to record the broadcast program data in the HDD 312 in the system section 31, the broadcast program data converted into the digital signal is sent to the MPEG2 encoder 223. The MPEG2 encoder 223 compresses and codes the broadcast program data. The compressed and coded broadcast program data is sent to the system section 31 through the PCI bus interface (PCI I/F) 224 and the bus 10. To record the broadcast program data received by the TV tuner 221 in the HDD 312 in the system section 31 while outputting the broadcast program data to the TV receiver 102, the broadcast program data converted into the digital signal by the analog-digital converter (ADC) 222 is supplied to both the selector 236 and the MPEG2 encoder 223.

The MPEG2 decoder 225 decodes the compressed and coded broadcast program data. The MPEG2 decoder 225 is used to output the compressed and coded broadcast program data recorded in the HDD 312 in the system section 31 to the TV receiver 102. Thus, the first AV path 211 executes reception processing of broadcast data and broadcast data processing to record and reproduce the received broadcast data.

Like the first AV path 211, the second AV path 212 also includes a TV tuner 231, an analog-digital converter (ADC) 232, an MPEG2 encoder 233, a PCI bus interface (PCI I/F) 234, and an MPEG2 decoder 235. The functions of these components are similar to the functions of the corresponding components of the first AV path 211.

The system section 31 includes a system control section 311, an HDD 312, a communication section 313, and a remote control controller 314. The system control section 311, the HDD 312, the communication section 313, and the remote control controller 314 are operated by a power supply V3 provided by the power supply section 41. The system control section 311 is a processor for controlling the operation of the wireless AV station 101. The system control section 311 controls the operation of the AV section 21 in response to a TV viewing request from a remote control unit, received by the remote control controller 314 and a TV viewing request from each of the information processing terminals 103 to 105, received by the communication section 313. The system control section 311 controls the operation of the AV section 21 based on recording program information set by each of the information processing terminals 103 to 105.

The communication section 313 is a device for executing a router function and executes data transfer between the home local network (wireless LAN 14, wire LAN 15) and the Internet 12.

The power supply section 41 is a power supply unit for supplying operation power to each of the modules making up the wireless AV station 101. The power supply section 41 controls the power supply V1 to the AV path 212, the power supply V2 to the AV path 212, and the power supply V3 to the system section 31 separately in response to a power supply control signal from the power supply control section 42.

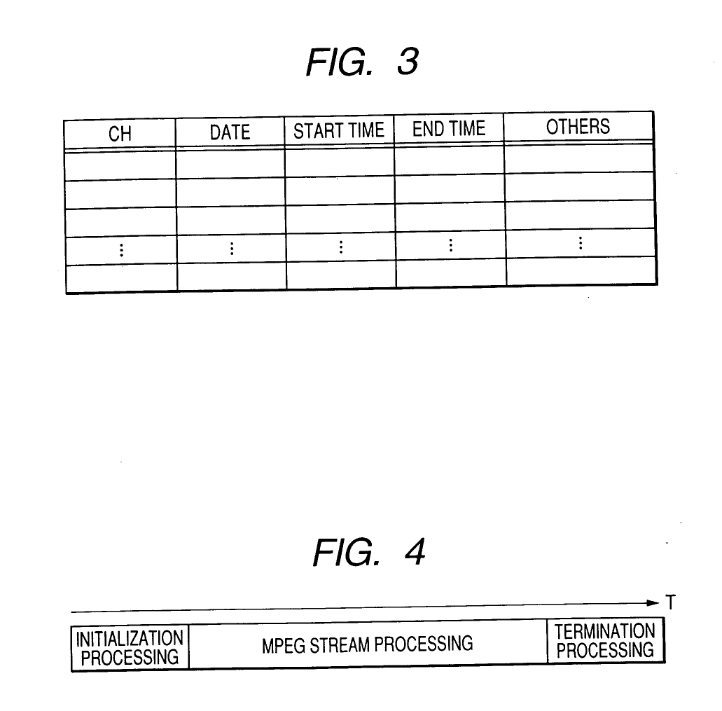

FIG. 3 shows an example of recording program information managed by the system control section 311. The recording program information is stored in nonvolatile memory in the system control section 311 or in the HDD 312.

The recording program information contains the following information for each program:
CH: Channel number of channel to record
Date: Recording start years, months, days
Start time: Recording start time
End time: Recording end time

FIG. 4 shows a processing sequence required for storing the broadcast program data specified with the recording program information in the HDD 312.

Initialization processing is recording preparation processing executed before the start time of recording specified with the recording program information. In the initialization processing, a file to store the broadcast program specified with the recording program information is created and opened. In the initialization processing, processing of initializing the TV tuner 221 or 231 and specifying the channel number of the channel to be received for the TV tuner 221 or 231 is also executed.

In MPEG stream processing, processing of compressing and coding the broadcast program data received by the TV tuner 221 or 231 and processing of storing the compressed and coded data in the file created in the HDD 312 in predetermined data size units in order through a data buffer are executed.

Termination processing is postprocessing executed after the end time of recording specified with the recording program information. In the termination processing, processing of storing the data left in the HDD 312 after the reception termination of the broadcast program data specified with the recording program information in the file created in the HDD 312, processing of closing the file and confirming file attribute information of the file size, the file creation date and time, etc., and the like are executed.

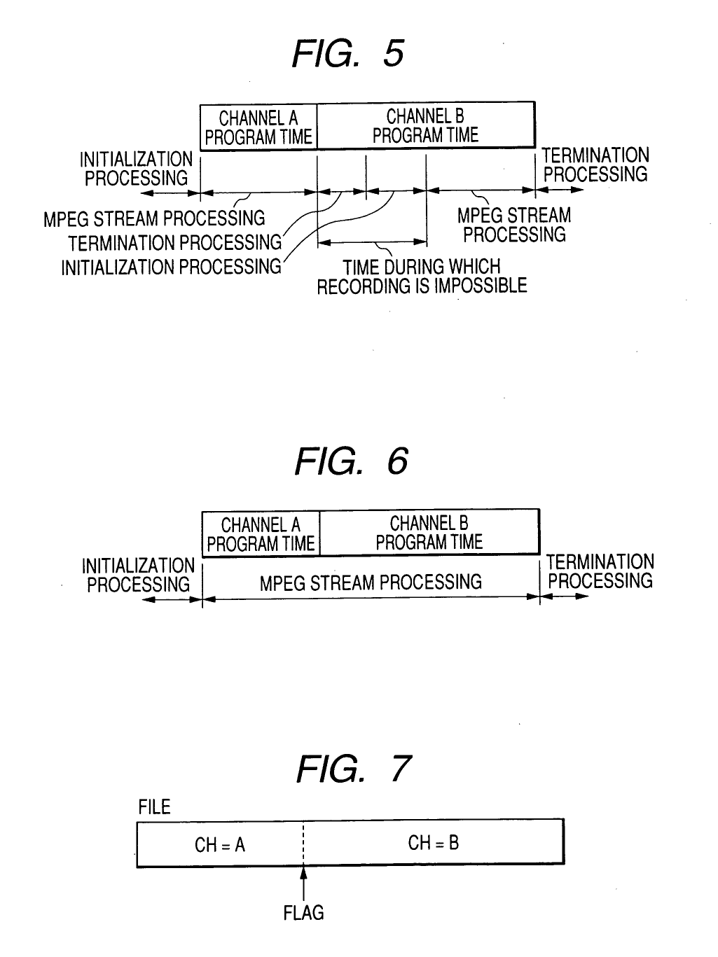

Next, recording processing to be performed if recording of two pieces of broadcast program data on channel A and channel B broadcast consecutively is programmed will be discussed with reference to FIGS. 5 and 6.

FIG. 5 shows processing for storing the two pieces of broadcast program data on channel A and channel B as different files. After the recording end time of the broadcast program data on channel A, it becomes necessary to execute the termination processing corresponding to the broadcast program data on channel A and the initialization processing corresponding to the broadcast program data on channel B. Thus, during the time period, it becomes impossible to record the broadcast program data on channel B. Then, in the embodiment, processing of storing the two pieces of broadcast program data on channel A and channel B consecutively in one file is executed as shown in FIG. 6.

That is, in the embodiment, the two pieces of broadcast program data on channel A and channel B are processed as one consecutive broadcast program data piece. If reception of the broadcast program data on channel A terminates, the termination processing corresponding to the broadcast program data on channel A is not executed and the channel is switched from channel A to channel B with the MPEG stream processing continued. The broadcast program data on channel B is stored in the already created file corresponding to the broadcast program data on channel A. Thus, processing of creating the file to store the broadcast program data on channel B need not be executed. At the termination of reception of the broadcast program data on channel B, the termination processing containing processing of storing the broadcast program data on channel B left in the data buffer in the file and processing of closing the file is executed.

Channel switching during the MPEG stream processing can be accomplished according to any of the following methods:

To use one TV tuner, a channel switching command may be issued to the TV tuner during the MPEG stream processing.

At the channel switching time, several frames of video are placed out of frame synchronization. Thus, the several-frame video may be excluded from the object of compression and coding.

In the embodiment, the two TV tuners 221 and 231 are provided. The broadcast program data on channel A is received by the TV tuner 221 and the broadcast program data on channel B is received by the TV tuner 231, whereby a problem caused by the loss of frame synchronization does not occur.

FIG. 7 shows a format example of the file containing the broadcast program data on channel A and the broadcast program data on channel B. FLAG in FIG. 7 is information indicating the boundary position between the broadcast program data on channel A and the broadcast program data on channel B. The FLAG is used to later divide the file containing the broadcast program data on channel A and the broadcast program data on channel B into a file containing the broadcast program data on channel A and a file containing the broadcast program data on channel B.

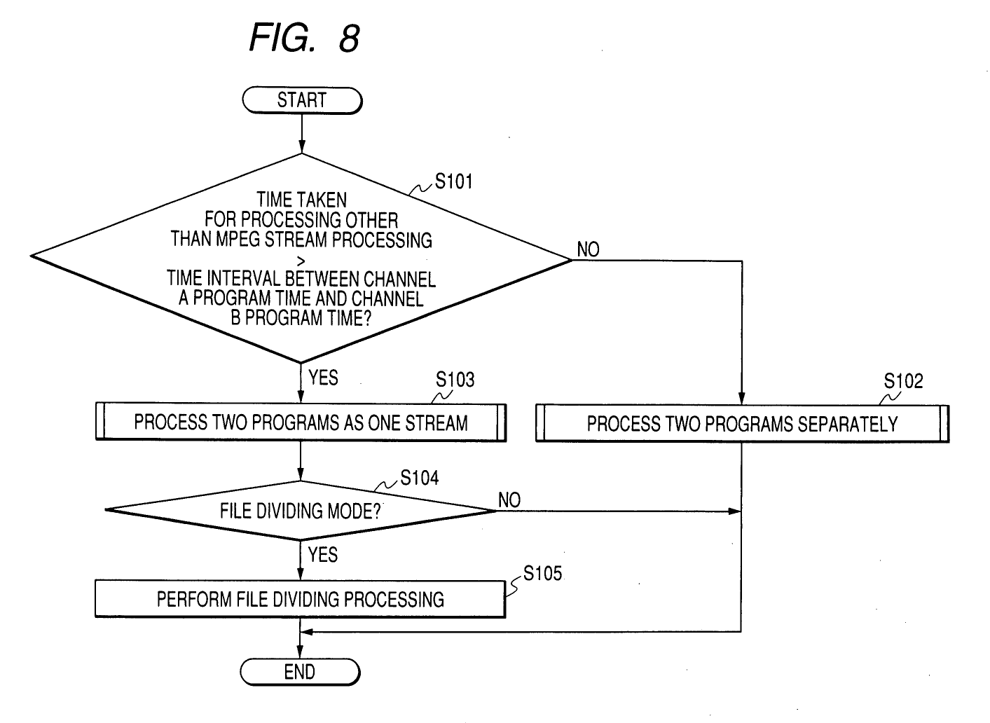

Next, recording control processing executed by the system control section 311 will be discussed with a flowchart of FIG. 8.

The system control section 311 references the recording program information and determines whether or not the time interval between the time to terminate recording of the broadcast program data on channel A and the time to start recording of the broadcast program data on channel B is shorter than a predetermined value (step S101). The predetermined value corresponds to the time required for processing (initialization processing and termination processing) other than the MPEG stream processing.

If the time interval between the time to terminate recording of the broadcast program data on channel A and the time to start recording of the broadcast program data on channel B is equal to or greater than the predetermined value (NO at step S101), the system control section 311 executes recording control processing to separately process the broadcast program data on channel A and the broadcast program data on channel B (step S102). At step S102, first the initialization processing corresponding to the broadcast program data on channel A is executed before the recording start time of the broadcast program data on channel A. In the initialization processing, creation and opening processing of the file to store the broadcast program data on channel A and processing of setting the reception channel of the TV tuner to channel A are executed.

When the recording start time of the broadcast program data on channel A is reached, the MPEG stream processing is started. When the recording end time of the broadcast program data on channel A is reached, the termination processing is executed. In the termination processing, processing of storing the data left in the data buffer in the file and processing of closing the file are executed. Next, the initialization processing corresponding to the broadcast program data on channel B is executed before the recording start time of the broadcast program data on channel B. In the initialization processing, creation and opening processing of the file to store the broadcast program data on channel B and processing of setting the reception channel of the TV tuner to channel B are executed.

When the recording start time of the broadcast program data on channel B is reached, the MPEG stream processing is started. When the recording end time of the broadcast program data on channel B is reached, the termination processing is executed. In the termination processing, processing of storing the data left in the data buffer in the file and processing of closing the file are executed.

As the processing is performed, the broadcast program data on channel A and the broadcast program data on channel B are stored in the HDD 312 as two different files.

If the time interval between the time to terminate recording of the broadcast program data on channel A and the time to start recording of the broadcast program data on channel B is shorter than the predetermined value (YES at step S101), the system control section 311 executes recording control processing to process the broadcast program data on channel A and the broadcast program data on channel B as one stream (step S103). At step S103, first the initialization processing is executed before the recording start time of the broadcast program data on channel A. In the initialization processing, creation and opening processing of the file to store the broadcast program data on channel A and the broadcast program data on channel B and processing of setting the reception channel of the TV tuner to channel A are executed. When the recording start time of the broadcast program data on channel A is reached, the MPEG stream processing is started.

When the recording end time of the broadcast program data on channel A is reached, processing of switching the reception channel of the TV tuner from channel A to channel B is executed while the MPEG stream processing is continued.

At the switching time, processing of adding the FLAG indicating the boundary between the broadcast program data on channel A and the broadcast program data on channel B to the file is also performed. When the recording end time of the broadcast program data on channel B is reached, the termination processing is executed. In the termination processing, processing of storing the data left in the data buffer in the file and processing of closing the file are executed.

As the processing is performed, the broadcast program data on channel A and the broadcast program data on channel B are stored in the HDD 312 as one file.

After this, whether or not a file dividing mode for dividing the file into files provided in a one-to-one correspondence with the broadcast program data pieces is effective is determined (step S104). Whether or not the file dividing mode is effective can be prespecified by the user. If the file dividing mode is effective (YES at step S104), the system control section 311 executes processing of dividing the file containing the broadcast program data on channel A and the broadcast program data on channel B into a file containing the broadcast program data on channel A and a file containing the broadcast program data on channel B according to the FLAG (step S105). As the file is divided into the two files, it is made possible to easily play back the recorded broadcast program data on channel B from the beginning.

As described above, according to the embodiment, two pieces of the broadcast program data on channel A and the broadcast program data on channel B are recorded as one consecutive broadcast program data. Accordingly, the two broadcast program data pieces are stored in one file. Thus, it is made possible to normally record a plurality of pieces of broadcast program data on different channels broadcast consecutively.

In the embodiment, the received broadcast program data is compressed and coded before it is stored, but compression and coding processing is not necessarily required.

Further, reception units such as tuners may be provided externally.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

In addition, a program for attaining the functions in the embodiments may be recorded in a computer-readable recording medium. In this case, the program recorded in the recording medium is read and executed by a computer system. Incidentally, the “computer system” mentioned here includes an operation system or hardware such as peripheral equipment.

In addition, the “computer system” includes a homepage providing environment (or display environment) when it uses a WWW system.

On the other hand, the “computer-readable recording medium” means a portable medium such as a flexible disk, a magneto-optical disk, a ROM or a CD-ROM, or a storage unit such as a hard disk included in the computer system. Further the “computer-readable recording medium” includes a medium for holding the program for a predetermined time, such as a volatile memory (RAM) in a computer system as a server or a client when the program is transmitted through a network such as the Internet or a communication circuit such as a telephone circuit.

In addition, the program may be transmitted from a computer system storing the program in a storage unit or the like to another computer system through a transmission medium or by a transmitted wave in the transmission medium.

Here, the “transmission medium” for transmitting the program means a medium having a function of transmitting information, including a network (communication circuit) such as the Internet or a communication circuit (communication line) such as a phone line.

In addition, the program may be prepared for attaining a part of the aforementioned functions. Further, the program may be a so-called difference file (difference program) which can attain the aforementioned functions in combination with a program which has been already recorded in the computer system.

Further, these modifications may be used selectively and suitably in combination.

What is claimed is:

1. A recording apparatus capable of recording in storage broadcast program data on a first channel and broadcast program data on a second channel specified with recording program information, the recording apparatus comprising:
a determining unit configured to determine whether or not a time interval between a time to terminate recording of the broadcast program data on the first channel and a time to start recording of the broadcast program data on the second channel is shorter than a predetermined value; and
a recording control unit configured to execute recording processing of recording the broadcast program data on the first channel and the broadcast program data on the second channel as consecutive broadcast program data when the time interval is shorter than the predetermined value.

2. The recording apparatus as claimed in claim 1, further comprising a reception unit configured to receive the broadcast program data on the first channel and the broadcast program data on the second channel.

3. The recording apparatus as claimed in claim 1, wherein when the time interval is not shorter than the predetermined value, the recording control unit executes second recording processing of recording the broadcast program data on the first channel and the broadcast program data on the second channel as separate broadcast program data pieces.

4. The recording apparatus as claimed in claim 1, wherein the recording processing contains processing of storing the broadcast program data on the first channel and the broadcast program data on the second channel in one file created in the storage; and
the recording apparatus further comprising a file dividing unit configured to divide the one file into a file containing the broadcast program data on the first channel and a file containing the broadcast program data on the second channel.

5. The recording apparatus as claimed in claim 4, wherein the recording processing contains processing of adding information indicating a boundary position between the broadcast program data on the first channel and the broadcast program data on the second channel in the one file to the one file; and
the file dividing unit divides the one file into the file containing the broadcast program data on the first channel and the file containing the broadcast program data on the second channel based on the information indicating the boundary position.

6. The recording apparatus as claimed in claim 1, wherein the recording processing contains:
initialization processing containing at least processing of creating one file;
storage processing of storing the broadcast program data on the first channel and the broadcast program data on the second channel in the one file in predetermined data size units in order through a data buffer; and
termination processing containing processing of storing the data left in the data buffer in the one file after completion of reception of the broadcast program data on the second channel and processing of closing the one file.

7. The recording apparatus as claimed in claim 3, wherein the second recording processing contains:
first initialization processing containing at least processing of creating a first file to store the broadcast program data on the first channel;
first storage processing of storing the broadcast program data on the first channel in the first file in predetermined data size units in order through a data buffer;
first termination processing containing processing of storing the data left in the data buffer in the first file after completion of reception of the broadcast program data on the first channel and processing of closing the first file;
second initialization processing containing at least processing of creating a second file to store the broadcast program data on the second channel;
second storage processing of storing the broadcast program data on the second channel in the second file in predetermined data size units in order through a data buffer; and
second termination processing containing processing of storing the data left in the data buffer in the second file after completion of reception of the broadcast program data on the second channel and processing of closing the second file.

8. A recording control method for recording in storage broadcast program data on a first channel and broadcast program data on a second channel specified with recording program information, the comprising:
receiving the broadcast program data on the first channel and the broadcast program data on the second channel;
determining whether or not a time interval between a time to terminate recording of the broadcast program data on the first channel and a time to start recording of the broadcast program data on the second channel is shorter than a predetermined value; and
executing recording processing of recording the received broadcast program data on the first channel and the received broadcast program data on the second channel as one consecutive broadcast program data when the time interval is shorter than the predetermined value.

9. The recording control method as claimed in claim 8, wherein when the time interval is not shorter than the predetermined value, second recording processing of recording the received broadcast program data on the first channel and the received broadcast program data on the second channel as separate broadcast program data pieces is executed.

10. The recording control method as claimed in claim 8, wherein the recording processing contains processing of storing the received broadcast program data on the first channel and the received broadcast program data on the second channel in one file created in the storage; and
the recording control method further comprises dividing the one file into a file containing the broadcast program data on the first channel and a file containing the broadcast program data on the second channel.

11. The recording control method as claimed in claim 10, wherein the recording processing contains processing of adding information indicating a boundary position between the broadcast program data on the first channel and the broadcast program data on the second channel in the one file to the one file; and
during dividing, the one file is divided into the file containing the broadcast program data on the first channel and the file containing the broadcast program data on the second channel based on the information indicating the boundary position.

12. The recording control method as claimed in claim 8, wherein the recording processing contains:
initialization processing containing at least processing of creating one file;
storage processing of storing the received broadcast program data on the first channel and the received broadcast program data on the second channel in the one file in predetermined data size units in order through a data buffer; and
termination processing containing processing of storing the data left in the data buffer in the one file after completion of reception of the broadcast program data on the second channel and processing of closing the one file.

13. The recording control method as claimed in claim 9, wherein the second recording processing contains:
first initialization processing containing at least processing of creating a first file to store the broadcast program data on the first channel;
first storage processing of storing the received broadcast program data on the first channel in the first file in predetermined data size units in order through a data buffer;
first termination processing containing processing of storing the data left in the data buffer in the first file after completion of reception of the broadcast program data on the first channel and processing of closing the first file;
second initialization processing containing at least processing of creating a second file to store the broadcast program data on the second channel;
second storage processing of storing the received broadcast program data on the second channel in the second file in predetermined data size units in order through a data buffer; and
second termination processing containing processing of storing the data left in the data buffer in the second file after completion of reception of the broadcast program data on the second channel and processing of closing the second file.

14. A computer readable medium configured to store a set of instructions for operating a computer in an recording apparatus, the instructions comprising:
receiving the broadcast program data on the first channel and the broadcast program data on the second channel;
determining whether or not a time interval between a time to terminate recording of the broadcast program data on the first channel and a time to start recording of the broadcast program data on the second channel is shorter than a predetermined value; and
executing recording processing of recording the received broadcast program data on the first channel and the received broadcast program data on the second channel as one consecutive broadcast program data when the time interval is shorter than the predetermined value.
